(19) United States
(12) Patent Application Publication
(10) Pub. No.: US 2017/0225738 A1
(43) Pub. Date: Aug. 10, 2017

(54) RECREATIONAL BICYCLE

(71) Applicant: YVOLVE SPORTS LTD., Dublin (IE)

(72) Inventor: Thomas O Connell, Castleblayney (IE)

(73) Assignee: YVOLVE SPORTS LTD., Dublin (IE)

(21) Appl. No.: 15/518,959

(22) PCT Filed: Nov. 6, 2015
(86) PCT No.: PCT/EP2015/075998

§ 371 Date: Apr. 13, 2017

(30) Foreign Application Priority Data
Nov. 6, 2014 (CN) 201410638023.5

(51) Int. Cl. B62K 13/00; B62H 7/00; B62K 9/02

(52) U.S. Cl. CPC B62K 13/00; B62K 9/02; B62H 7/00; B62K 13/04

(57) ABSTRACT

A vehicle (1) is provided and includes a frame (10), a seat (20), front and rear wheel sets (1012, 1014) provided at front and rear ends of the frame, and a handlebar (30). A wheel set is an adjustable wheel set that includes a wheel support (1016), a first wheel (52b) and a second wheel (52c) rotatably supported on the wheel support. The wheel support includes a first connector (60) pivotably mounted to the frame for pivoting movement about a connector axis that lies in a generally vertical-longitudinal plane. The wheel support is pivotable between a first position in which the wheel support holds the first and second wheels canted such that their upper ends are closer together than their lower ends, and a second position in which their upper ends of the first and second wheels are farther from one another than their lower ends.

### CROSS-REFERENCE TO RELATED APPLICATIONS

This application claims the benefit of Chinese Patent Application No. 201420681388.1, filed on Nov. 6, 2014, the contents of which of which is incorporated herein by reference in its entirety.

### FIELD OF INVENTION

The present invention relates to a recreational bicycle, particularly to a recreational bicycle that at least allows the regulation of the width of the contact surface between the front wheel set or rear wheel set and the ground, thereby increasing use versatility and improving applicability and practicability.

### BACKGROUND OF INVENTION

Traditionally, when a child learns bicycling, in most cases, balance is maintained by other persons who provide assistance or by auxiliary wheels at the rear. However, similar practices are not very effective in helping children to learn to ride a bicycle more quickly, at best balancing a bicycle to prevent a child from falling from the bicycle. Over time, a child becomes dependent on the assistance, which is not good for giving full play to the child's potential equilibrium sense.

Therefore, recreational bicycles, also called scooters or mopeds, that have no pedals or chains compared with children's bicycles have emerged. In such a recreational bicycle, the front end of a frame is axially equipped with a front fork that provides a handlebar and a front wheel; the other end of the frame is axially equipped with a rear wheel; a seat is installed in the middle section of the frame. A child can sit in the seat, grip the handlebar with both hands, and stomp with both feet, driving the front wheel and rear wheel so that the recreational bicycle advances. Thus, the child can improve his or her muscle force and equilibrium.

In a similar conventional recreational bicycle, the front wheel set and the rear wheel set respectively comprise a single wheel. Therefore, in normal conditions, such a recreational bicycle slides with the treads of each wheel coming into contact with the ground. In addition, to allow flexible operations, there are no significant differences between the tread widths of each wheel and the widths of the tires of traditional children's bicycles, and the tread widths of wheels cannot be adjusted. Therefore, it is rather difficult to learn bicycling with such a recreational bicycle. Moreover, it is rather difficult and dangerous for younger children to learn to ride or use such a recreational bicycle. Consequently, the applicability and practicability of such recreational bicycles is significantly reduced.

### SUMMARY

To solve the above-mentioned technical problem, embodiments of the present disclosure provides a recreational bicycle that at least allows the regulation of the width of the contact surface between the front wheel set or rear wheel set and the ground, thereby increasing use versatility and improving applicability and practicability.

In some embodiments a seat is provided on a frame; a front wheel set and a rear wheel set are provided at the front end and at the rear end, respectively, of said frame for coming into contact with the ground, and a handlebar is provided at the front end of said frame, wherein: said recreational bicycle is equipped with at least one wheel at the front wheel set or rear wheel set; said wheel is provided with a first wheel face and a second wheel face that are opposite to each other; said first wheel face and second wheel face are not parallel to each other; said wheel is installed on said frame by using a live shaft that can motion relative to said frame; a fixing component is equipped between said frame and said live shaft to control whether said live shaft can motion relative to said frame or not.

With the above-mentioned structural features the bicycle is equipped with a first wheel face and a second wheel face that are not parallel to each other at the front wheel set or rear wheel set, allowing the wheel to have a side with a smaller tread spacing interval and the other side with a larger tread spacing interval. Therefore, with the cooperation of a fixing component, a recreational bicycle can be used conveniently by selecting the side of the wheel with a larger tread spacing interval for coming into contact with the ground or by selecting the side of the wheel with a smaller tread spacing interval for coming into contact with the ground. Thus, when a recreational bicycle is used with the side of the wheel that has a larger tread spacing interval coming into contact with the ground, the recreational bicycle becomes more stable when advancing, helping younger children to learn to ride and use such recreational bicycles; when a recreational bicycle is used with the side of the wheel that has a smaller tread spacing interval coming into contact with the ground, the recreational bicycle remains flexible when advancing, achieving the utmost riding delight.

According to the above-mentioned main structural characteristics, said front wheel set is provided with one wheel and said rear wheel set is provided with two wheels, with the axial lines of the two wheels of said rear wheel set not on the same horizontal line.

According to the above-mentioned main structural characteristics, said front wheel set is provided with two wheels, with the axial lines of the two wheels of said front wheel set not on the same horizontal line, and said rear wheel set is provided with one wheel.

In some embodiments, a recreational bicycle disclosed herein provides the following benefits.

1. The widths of the contact surfaces between the wheel sets and the ground can be regulated on the basis of the user's age and degree of skill to improve practicality and riding safety.

2. The use needs of young children in various age groups can be met, achieving higher applicability.

3. When the side of a wheel of the front rear wheel set or that of the rear wheel set having a larger tread spacing interval comes into contact with the ground, the recreational bicycle can be parked or put aside in an upright position, featuring higher convenience.

In another aspect, a vehicle is provided and includes a frame, a seat mounted to the frame, a front wheel set and a rear wheel set provided at a front end and at a rear end, respectively, of the frame for supporting the vehicle on a ground surface, and a handlebar provided at the front end of said frame and configured for steering the front wheel set. At least one of the front wheel set and rear wheel set of the vehicle is an adjustable wheel set that includes a wheel support, a first wheel and a second wheel which are rotatably supported on the wheel support. The wheel support includes a first connector that is pivotably mounted to the frame for pivoting movement about a connector axis that lies in a generally vertical-longitudinal plane when the vehicle is upright. The wheel support is pivotable about the connector axis between a first position in which the wheel support holds the first and second wheels canted such that upper ends of the first and second wheels are closer together than lower ends of the first and second wheels, and a second position in which the wheel support holds the first and second wheels canted such that the upper ends of the first and second wheels are farther from one another than the lower ends of the first and second wheels.

### BRIEF DESCRIPTION OF THE DRAWINGS

FIG. 1 shows a perspective view of a vehicle according to an embodiment of the present disclosure, in a first position.

FIG. 2 shows a rear elevation view of the vehicle shown in FIG. 1, in the first position.

FIG. 3 shows a perspective view of the vehicle shown in FIG. 1, in a transitional state between the first position and a second position.

FIG. 4 shows side elevation view of the vehicle shown in FIG. 1, in the transitional state between the first position and a second position shown in FIG. 3.

FIG. 5 shows a perspective view of the vehicle shown in FIG. 1, in the second position.

FIG. 6 shows a rear elevation view of the vehicle shown in FIG. 1, in the second position.

### DETAILED DESCRIPTION OF EMBODIMENTS

In some embodiments, a vehicle 1, which may be, for example, a recreational bicycle, is provided. The vehicle 1 has a frame 10 and allows the regulation of the width of the contact surface at least one of a front wheel set 1012 and a rear wheel set 1014 and a ground surface G. The first and second wheel sets 1012 and 1014 support the vehicle 1 on the ground surface G.

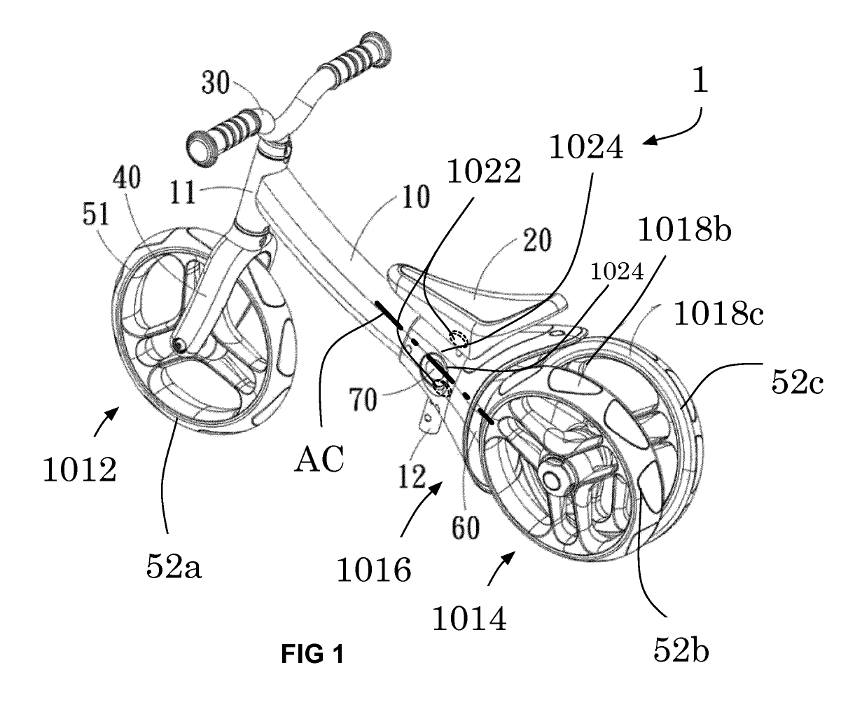

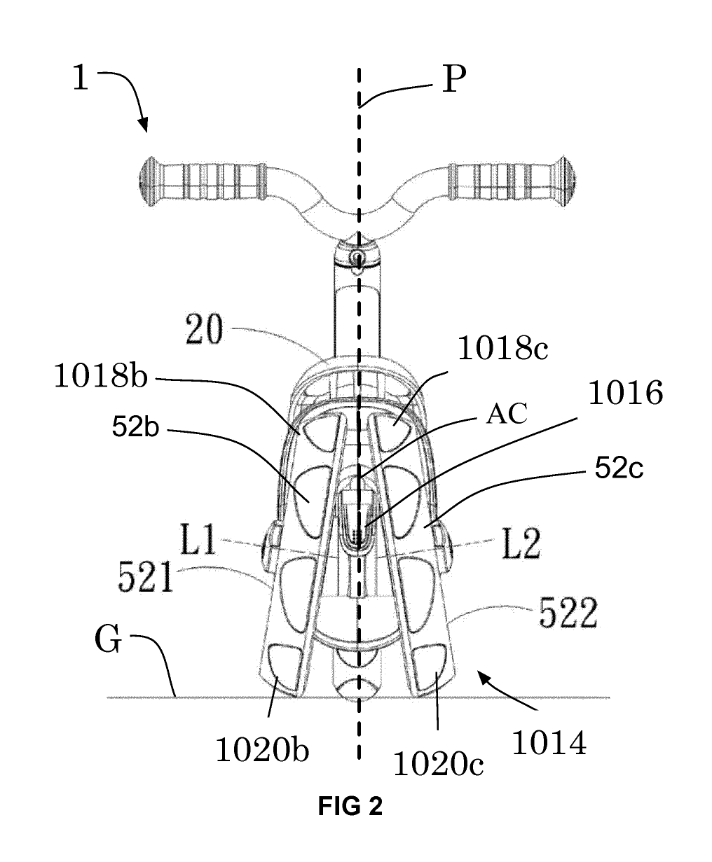

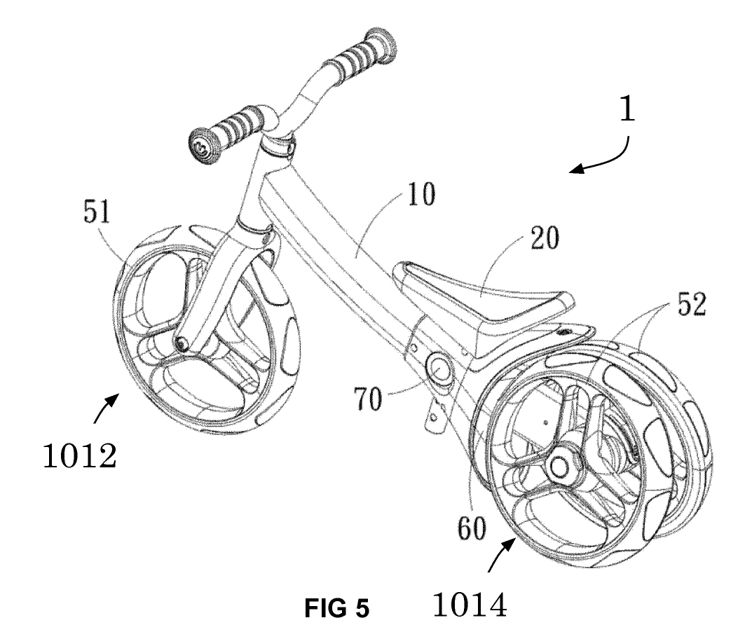

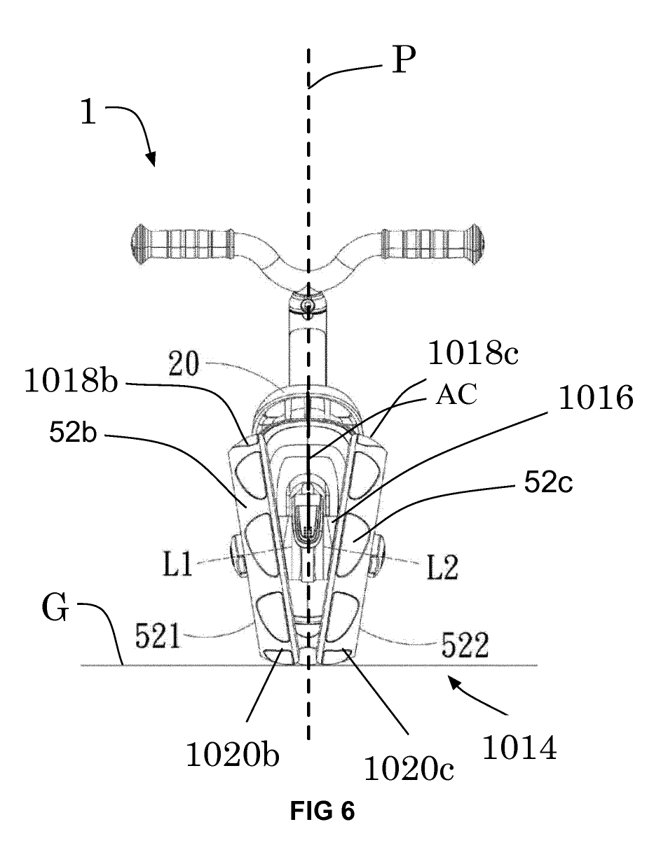

One of the wheel sets 1012 and 1014 (in the example shown, the rear wheel set 1014) is adjustable and may be referred to herein as the adjustable wheel set 1014, in the sense that it is positionable in a first position (FIGS. 1 and 2) and a second position (FIGS. 5 and 6).

More particularly, the adjustable wheel set 1014 includes an adjustable wheel set wheel support 1016, a first wheel 52b and a second wheel 52c which are rotatably supported on the wheel support 1016. The wheel support 1016 includes a first connector 60, which may be referred to below as a live shaft 60. The first connector 60 is pivotably mounted to the frame 10 for pivoting movement about a connector axis (FIG. 1) that lies in a generally vertical-longitudinal plane P (FIG. 2) when the vehicle 1 is upright. The longitudinal plane P generally bisects the vehicle 1 into left and right portions.

The wheel support 1016 is pivotable (about 180 degrees in some embodiments) about the connector axis AC between the first position (FIGS. 1 and 2) in which the wheel support holds the first and second wheels canted such that upper ends 1018b and 1018c of the first and second wheels 52b and 52c are closer together than lower ends 1020b and 1020c of the first and second wheels 52b and 52c, and a second position (FIGS. 5 and 6) in which the wheel support 1016 holds the first and second wheels 52b and 52c canted such that the upper ends 1018b and 1018c of the first and second wheels 52b and 52c are farther from one another than the lower ends 1020b and 1020c of the first and second wheels 52b and 52c.

In some embodiments, a seat 20 is provided on a frame 10; a front wheel set and a rear wheel set are provided at the front end and at the rear end, respectively, of said frame 10 for coming into contact with the ground, and a handlebar 30 is provided at the front end of said frame 10.

In some embodiments, a fixing component 70 is provided and is positionable in a locking position (FIGS. 1, 2, 5 and 6) to lock the wheel support 1016 in each of the first and second positions. In some embodiments, the seat 20 is supported on a seat post 12 that holds the seat 20 and that passes through a seat post receiving aperture 1022 on the frame 10. The post 12 is adjustable in height relative to the frame 10 and is lockable in a plurality of positions by the fixing component 70 which passes through a first fixing member receiving aperture 1024 on the frame 10 and one of a plurality of first post apertures 1026 on the post 12.

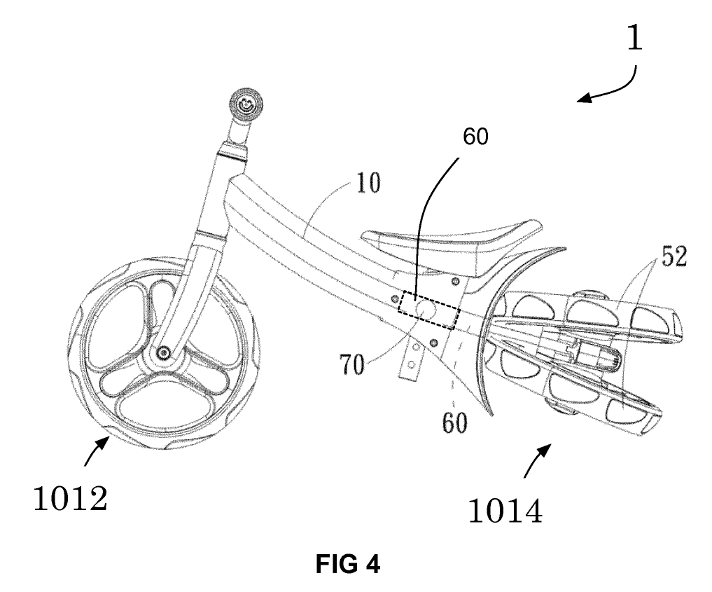

In some embodiments, the first connector 60 is a shaft (shown in FIG. 4) that is received in a second connector 62 that is a tube (FIG. 4), which may be provided in the frame 10.

In some embodiments, at the front end and middle section, respectively, of the frame 10, the recreational bicycle is provided with a front tube 11 and a seat tube 12; said front tube 11 is provided with a front fork 40, and said handlebar 30 is provided at the upper end of said front fork 40; said front wheel set is provided with a wheel 51 that is axially installed at the lower end of said front fork 40; and said seat 20 is installed on said seat tube 12.

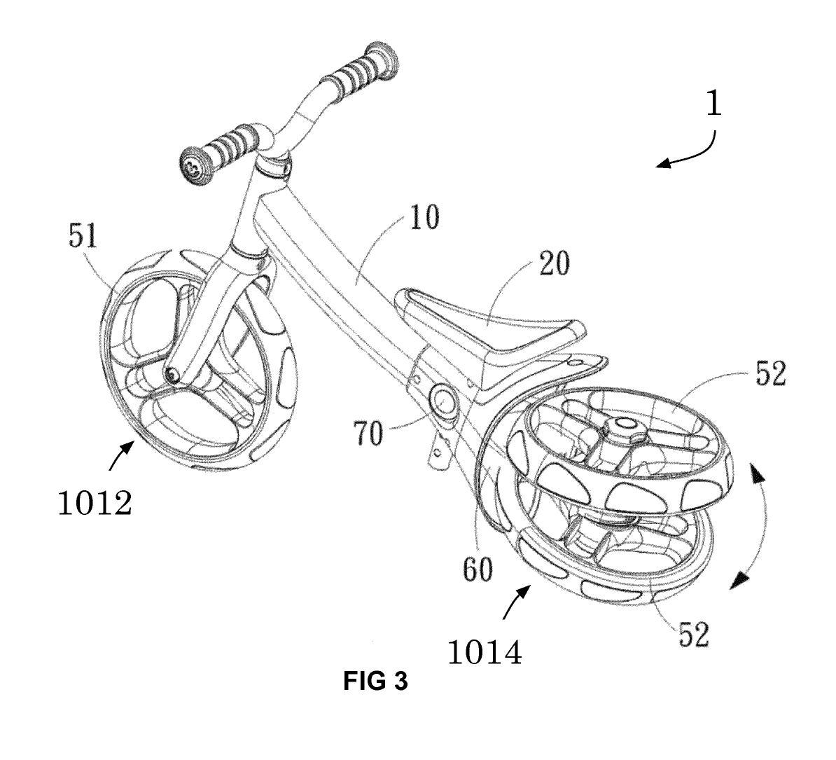

In some aspect of the present disclosure, the recreational bicycle 1 is provided with at least one wheel at least at its rear wheel set. In each of the embodiments shown in the figures, the front wheel set is provided with one wheel 52a; the rear wheel set is provided with two wheels 52b and 52c arranged in parallel; the wheels 52b and 52c are provided with a first wheel face 521 and a second wheel face 522; the first wheel face 521 and the second wheel face 522 are equipped on both external sides of the wheels 52b and 52c; the first wheel face 521 and the second wheel face 522 are not parallel to each other; the axial lines L1 and L2 of the two wheels 52b and 52c of the rear wheel set are not on the same horizontal line; thus, the wheels 52b and 52c have a side with a smaller tread spacing interval and the other side with a larger tread spacing interval; the wheels 52b and 52c are installed on the frame 10 by using a live shaft 60 that can motion relative to the frame 10; a fixing component 70 is equipped between the frame 10 and the live shaft 60 to control whether the live shaft 60 can motion relative to the frame 10 or not. That is, as shown in FIG. 3 and FIG. 4, the live shaft 60 is released by using the fixing component 70 and, under the action of the live shaft 60, the two wheels 52b and 52c of the rear wheel set 1014 can achieve the effect of being wider in the upper part and narrower in the lower part or being narrower in the upper part and wider in the lower part; in addition, by using the fixing component 70, the two wheels 52b and 52c of the rear wheel set 1014 can be used in the fixed state of being wider in the upper part and narrower in the lower part or being narrower in the upper part and wider in the lower part.

Alternatively, two wheels can be arranged in parallel in the front wheel set (not shown in any of the figures) in similar fashion to the arrangement shown for the rear wheel set 1014.

A recreational bicycle provided in an aspect of the present disclosure is equipped with a first wheel face and a second wheel face not parallel to each other at its front wheel set or rear wheel set. Therefore, with the cooperation of a fixing component, a recreational bicycle can be used conveniently by selecting the side of the wheel with a larger tread spacing interval for coming into contact with the ground or by selecting the side of the wheel with a smaller tread spacing interval for coming into contact with the ground. Thus, when a recreational bicycle is used with the side of the wheel that has a larger tread spacing interval coming into contact with the ground, as shown in FIG. 1 and FIG. 2, the recreational bicycle becomes more stable when advancing, helping younger children to learn to ride and use such recreational bicycles; when a recreational bicycle is used with the side of the wheel that has a smaller tread spacing interval coming into contact with the ground, as shown in FIG. 5 and FIG. 6, the recreational bicycle remains flexible when advancing, achieving the utmost riding delight.

In addition, while children's balance bikes are used as examples in the above-mentioned embodiments, the present utility model can be applied to other recreational bicycles, such as scooters.

Specifically, a recreational bicycle disclosed in accordance with some aspects of the present invention provides the following benefits.

1. The widths of the contact surfaces between the wheel sets and the ground can be regulated on the basis of the user's age and degree of skill to improve practicality and riding safety.

2. The use needs of young children in various age groups can be met, achieving higher applicability.

3. When the side of a wheel of the front rear wheel set or that of the rear wheel set having a larger tread spacing interval comes into contact with the ground, the recreational bicycle can be parked or put aside in an upright position, featuring higher convenience.
L1, L2: axial line
10: frame
11: front tube
12: seat tube
20: seat
30: handlebar
40: front fork
51: wheel
52: wheel
521: first wheel face
522: second wheel face
60: live shaft
70: fixing component

1. A vehicle, comprising:
a frame;
a seat mounted to the frame;
a front wheel set and a rear wheel set provided at a front end and at a rear end, respectively, of said frame for supporting the vehicle on a ground surface, and a handlebar provided at the front end of said frame,
wherein at least one of the front wheel set and rear wheel set of said vehicle is an adjustable wheel set that includes a wheel support, a first wheel and a second wheel which are rotatably supported on the wheel support, wherein the wheel support includes a first connector that is pivotably mounted to the frame for pivoting movement about a connector axis that lies in a generally vertical-longitudinal plane when the vehicle is upright,
wherein the wheel support is pivotable about the connector axis between a first position in which the wheel support holds the first and second wheels canted such that upper ends of the first and second wheels are closer together than lower ends of the first and second wheels, and a second position in which the wheel support holds the first and second wheels canted such that the upper ends of the first and second wheels are farther from one another than the lower ends of the first and second wheels.

2. A vehicle as claimed in claim 1, wherein said rear wheel set is the adjustable wheel set.

3. A vehicle as claimed in claim 1, further comprising a fixing component that is positionable in a locking position to lock the wheel support in each of the first and second positions.

4. A vehicle as claimed in claim 3, wherein the seat is supported on a seat post that holds the seat and that passes through a seat post receiving aperture on the frame.

5. A vehicle as claimed in claim 1, wherein the first and second positions for the wheel support are about 180 degrees apart rotationally about the connector axis.

6. A vehicle as claimed in claim 1, wherein the first connector is a shaft that is received in a second connector that is a tube.
